(19) United States
(12) Patent Application Publication
(10) Pub. No.: US 2009/0244466 A1
(43) Pub. Date: Oct. 1, 2009

(54) Liquid Crystal Display Device

(75) Inventors: Toshio Tojo, Ichinomiya (JP); Nobuyasu Hayashi, Chonan (JP); Jun Ooida, Mobara (JP); Hideo Tanabe, Mobara (JP); Toshiki Kaneko, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, ltd.

(21) Appl. No.: 12/416,229

(22) Filed: Apr. 1, 2009

(30) Foreign Application Priority Data
Apr. 1, 2008 (JP) 2008-094873

(51) Int. Cl. G02F 1/1343; H01J 9/20

(52) U.S. Cl. 349/139; 445/46

(57) ABSTRACT

A liquid crystal display device which can decrease periodical stripe-shaped irregularities is provided. In an active-matrix-type liquid crystal display device, a width of a stripe-shaped irregularity generating region where distance between a pixel electrode and a counter electrode changes is set to 50 μm less. To be more specific, at the time of exposing a resist pattern on a TFT substrate, by scanning an exposure light plural times using a direct drawing exposure machine, a width of an overlapping region of exposure regions which is generated in scanning is set to 50 μm or less thus setting the width of the stripe-shaped irregularity generating region to 50 μm or less.

### CLAIM OF PRIORITY

The present invention claims priority from Japanese application serial No. 2008-94873, filed on Apr. 1, 2008, the content of which is hereby incorporated be reference into this application.

### BACKGROUND OF THE INVENTION

1. Field of the Invention

The present invention relates to a technique for enhancing image quality of a display device.

2. Description of the Related Art

Conventionally, an active-matrix-type liquid crystal display device has been popularly used as, for example, a display of a television receiver set or a personal computer or a display of portable electronic equipment such as a mobile phone or a portable gaming machine.

The active-matrix-type liquid crystal display device is a display device having a liquid crystal display panel which hermetically fills a liquid crystal material between a pair of substrates. The liquid crystal display panel includes a display region which is constituted of a mass of pixels each of which has a TFT element, a pixel electrode, a counter electrode and a liquid crystal material, for example.

One substrate out of the pair of substrates of the liquid crystal display panel is a printed circuit board which is constituted by forming a plurality of scanning signal lines, a plurality of video signal lines, a plurality of TFT elements, a plurality of pixel electrodes and the like on a surface of an insulation substrate such as a glass substrate. In general, such a substrate is referred to as an active matrix substrate or a TFT substrate. Further, another substrate out of the pair of substrates of the liquid crystal display panel is a substrate which is constituted by forming a light blocking film in mesh (black matrix), color filters and the like on a surface of an insulation substrate such as a glass substrate. In general, such a substrate is referred to as a counter substrate.

Further, the counter electrode is an electrode which forms a pair with the pixel electrode and generates an electric field for controlling the alignment of liquid crystal molecules in the liquid crystal material. The counter electrodes may be mounted on a TFT substrate side or on a counter substrate side.

Here, the TFT substrate is configured such that a plurality of conductor patterns, a plurality of semiconductor patterns and a plurality of insulation films are stacked on a surface of the insulation substrate thus forming, for example, scanning signal lines, video signal lines, TFT elements, pixel electrodes and the like on a surface of the TFT substrate. Here, the conductor patterns, the semiconductor patterns, and through holes formed in the insulation films are formed by etching. Accordingly, in a manufacturing method of the TFT substrate, a step of forming an etching resist by exposing and developing a photosensitive material film which is formed on a surface of a conductive film, a semiconductor film or an insulation film is performed plural times.

With respect to a manufacturing method of a TFT substrate, conventionally, it is often the case that a photosensitive material film is exposed by an exposure method which uses a photo mask. However, in a recent manufacturing method of a TFT substrate, the number of cases that a photosensitive material film is exposed by an exposure method which is referred to as a direct drawing exposure method or a direct exposure method has been increasing.

The direct drawing exposure method is an exposure method which does not use a photo mask. That is, the direct drawing exposure method is an exposure method in which, for example, a photosensitive material film is divided into numerous minute regions, the respective minute regions are sorted to minute regions to be exposed and minute regions not to be exposed based on preliminarily prepared layout data (numerical value data), and light is radiated to only the photosensitive material film in the minute regions to be exposed so as to expose the photosensitive material film in the minute regions thus directly drawing a latent image.

In a manufacturing method of a TFT substrate, to expose a photosensitive material by a direct drawing exposure method, usually, for example, the whole TFT substrate (exposure subject region) is divided into a plurality of strip-shaped regions, and a photosensitive material film is sequentially exposed for every strip-shaped region. Here, the photosensitive material film in one strip-shaped region may be collectively exposed or one strip-shaped region may be further divided into a plurality of blocks and the photosensitive material film may be exposed sequentially for every block.

Further, when the photosensitive material film is sequentially exposed for every strip-shaped region in exposing one photosensitive material film, usually, to prevent the formation of an unexposed region in a boundary portion between two neighboring strip-shaped regions, an overlapping region is provided to the boundary portion between two neighboring strip-shaped regions. That is, in sequentially exposing the photosensitive material film for every strip-shaped region, the exposure is performed by providing, between the first strip-shaped region and the second strip-shaped region arranged adjacent to the first strip-shaped region, the strip-shaped overlapping region which is exposed in both of the exposure of the photosensitive material film in the first strip-shaped region and the exposure of the photosensitive material film in the second strip-shaped region.

However, in performing the exposure of the photosensitive material film in the respective strip-shaped regions using the exposure device adopting the direct drawing exposure method, the exposure is performed by repeating the exposure of the strip-shaped region and the movement of a relative position between a light radiating position and the photosensitive material film. Here, the positioning accuracy of the exposure device is limited. Accordingly, when the photosensitive material film in a certain strip-shaped region is exposed, there may arise deviation between an exposure position designated on layout data and a position of a portion which is actually exposed.

A planar shape of a pattern which is obtained by etching which uses an etching resist formed by exposure at the time of exposing only the first strip-shaped region and an etching resist formed by exposure at the time of only exposing the second strip-shaped region as masks usually becomes congruent with or similar to a planar shape designated on layout data.

However, in the overlapping region between the first strip-shaped region and the second strip-shaped region, as mentioned previously, the positional deviation arises in the second-time exposure pattern and hence, the exposure in the overlapping range becomes excessive or insufficient. In such a case, the planar shape of the pattern in the overlapping region differs from the planar shape designated on layout data. That is, the planar shape of the pattern does not become congruent with or similar to the planar shape designated on layout data.

For example, with respect to an active-matrix-type liquid crystal display device of a lateral electric field drive type in which a comb-teeth-shaped pixel electrode and a comb-teeth-shaped counter electrode are arranged in the extending direction of a video signal line in fitting engagement, when a positive resist is used and the resist is deviated in the extending direction of a scanning signal line such that an overlapping area of exposure is increased, that is, when the exposure is performed excessively, electrode widths of the pixel electrode and the counter electrode formed in the overlapping region become narrow. Here, a gap between the pixel electrode and the counter electrode is increased compared to other region by an amount corresponding to narrowing of the electrode widths and hence, an electric field applied to liquid crystal is deviated from a predetermined value. In the conventional active-matrix-type liquid crystal display device of a lateral electric field drive type, stripe irregularities appear due to such a cause.

As a method which prevents the deformation (deviation) of the planar shape of the pattern generated in the overlapping region at the time of exposing the photosensitive material film by the direct drawing exposure method, there has been proposed, for example, a method in which additional exposure for correction is applied to an overlapping region which is exposed at the time of exposing a photosensitive material film in a first strip-shaped region and at the time of exposing a photosensitive material film in a second strip-shaped region (for example, see JP-A-2005-109508 (patent document 1)).

Further, as a method which prevents the deformation (deviation) of the planar shape of the pattern generated in the overlapping region at the time of exposing the photosensitive material film by the direct drawing exposure method, there has been also proposed, for example, a method in which an image defect in an overlapping region is identified after exposing a photosensitive material film in a first strip-shaped region, image data for correcting the defect is prepared and, thereafter, the photosensitive material film in a second strip-shaped region is exposed (for example, see JP-A-2005-109509 (patent document 2)).

### SUMMARY OF THE INVENTION

In patent document 1, in performing the exposure of the photosensitive material film for correction in the overlapping region, the exposure of the photosensitive material film in the overlapping region is performed three times. Accordingly, time necessary for exposure of one photosensitive material film is prolonged thus giving rise to a drawback that productivity of the TFT substrate is deteriorated. Further, in patent document 2, the photosensitive material film in the overlapping region is firstly exposed and, then, the image defect is identified and the imaged data for correction is prepared and, thereafter, the photosensitive material film in the overlapping region is secondarily exposed. Such a method has a drawback that a TFT substrate of a liquid crystal display device which is manufactured using a substrate larger than a substrate used for manufacturing semiconductors, for example, there arises a drawback that the identification of the image defect is extremely difficult.

That is, the above-mentioned related art is a technique which adopts an approach to decrease the deformation of a planar shape of the pattern per se generated in the overlapping region to zero and hence, it is difficult to apply the related art to the actual mass production of active-matrix-type display devices.

It is an object of the present invention to provide a technique which realizes an active-matrix-type display device which exhibits higher image quality.

It is another object of the present invention to provide a technique which can prevent lowering of productivity of TFT substrates even when a direct drawing exposure method is used in the manufacture of a TFT substrate of a liquid crystal display device, for example.

It is still another object of the present invention to provide a technique which can easily manufacture a liquid crystal display device in which periodical stripe-shaped irregularities are hardly observed, for example.

Inventors of the present invention have studied a different approach without adopting the approach disclosed in patent document 1 and patent document 2 which prevents the deformation per se of the planar shape of the pattern. To be more specific, the present invention adopts the approach which makes the recognition of the deformation of the planar shape of the pattern difficult. That is, the inventors have found that the above-mentioned drawbacks can be overcome by decreasing a size of periodical stripe-shaped irregularities in the liquid crystal display device to a level that human eyes cannot recognize with his/her naked eyes while accepting the presence of such stripe-shaped irregularities.

To explain the summary of typical inventions among the inventions disclosed in this specification, they are as follows.

In an active-matrix-type display device which includes pixel electrodes each of which has a portion extending in the extending direction of video signal lines, a width of stripe-shaped irregularities which are generated in the extending direction of the video signal line is set to 50 μm or less. Due to such constitution, it is possible to suppress a width of a region where an inter-electrode gap between a pixel electrode and a counter electrode which causes stripe-shaped irregularities differs from the gap of a pixel electrode and a counter electrode of a pixel in other region to 50 μm. As a method of realizing the present invention, an overlapping width of an exposure range by a direct drawing exposure machine can be set to 50 μm or less.

According to the display device of the present invention, it is possible to enhance image quality of an active-matrix-type liquid crystal display device, for example.

Further, according to the manufacturing method of a display device according to the present invention, it is possible to prevent lowering of productivity of the TFT substrate even when a direct drawing exposure method is used in manufacturing TFT substrates of a liquid crystal display device, for example.

### BRIEF DESCRIPTION OF THE DRAWINGS

FIG. 1A is a schematic plan view showing one example of the schematic constitution of a liquid crystal display panel according to the present invention;

FIG. 1B is a schematic plan view showing one example of the schematic constitution of one pixel of a TFT substrate of the liquid crystal display panel shown in FIG. 1A;

FIG. 1C is a schematic cross-sectional view showing one example of the cross-sectional constitution taken along a line A-A′ in FIG. 1B;

FIG. 1D is a schematic cross-sectional view showing one example of the cross-sectional constitution taken along a line B-B′ in FIG. 1B;

FIG. 2A is a schematic plan view showing exposure steps in exposing a photosensitive material film by a direct drawing exposure method in a manufacturing step of a TFT substrate;

FIG. 2B is a schematic plan view showing an area in FIG. 2A in an enlarged manner;

FIG. 2C is a schematic graph showing one example of the distribution of light quantity of exposure beams;

FIG. 3A is a schematic plan view showing an ideal planar layout of pixel electrodes and counter electrodes;

FIG. 3B is a schematic plan view showing one example of a size of an overlapping region in a conventional liquid crystal display device;

FIG. 4A is a schematic plan view showing one example of a change of planar shapes of the pixel electrodes and counter electrodes which occurs in an overlapping region;

FIG. 4B is a schematic plan view showing one example of a size of an overlapping region in a liquid crystal display device to which the present invention is applied;

FIG. 5A is a schematic view showing one example of the schematic constitution of an exposure device of a direct drawing exposure method;

FIG. 5B is a schematic graph showing one example of the distribution of light quantity of light radiated when one strip-shaped region is exposed;

FIG. 5C is a schematic graph showing one example of the distribution of a line width in a conventional exposure method; and

FIG. 6 is a schematic graph showing one example of manner of operation and advantageous effects of a manufacturing method of a TFT substrate of an embodiment 2 according to the present invention.

### DESCRIPTION OF THE PREFERRED EMBODIMENTS

Hereinafter, the present invention is explained in detail in conjunction with embodiments by reference to the drawings.

Here, in all drawings for explaining the embodiments, parts having identical functions are given same numerals and their repeated explanation is omitted.

### Embodiment 1

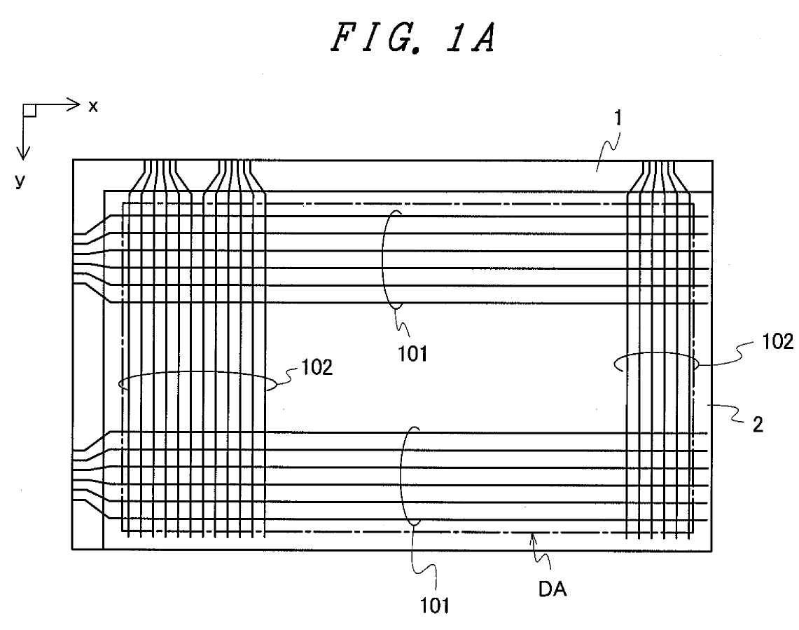

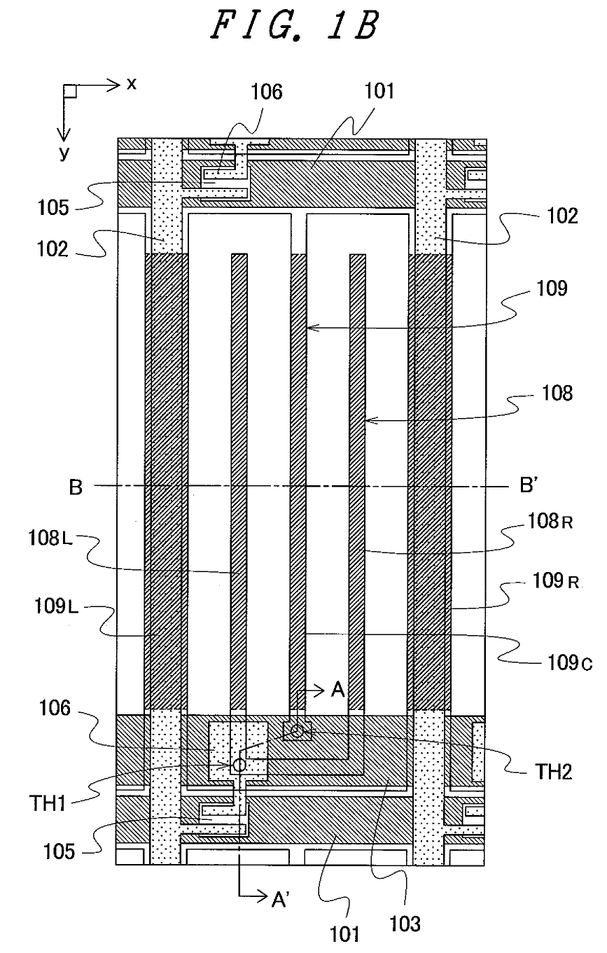

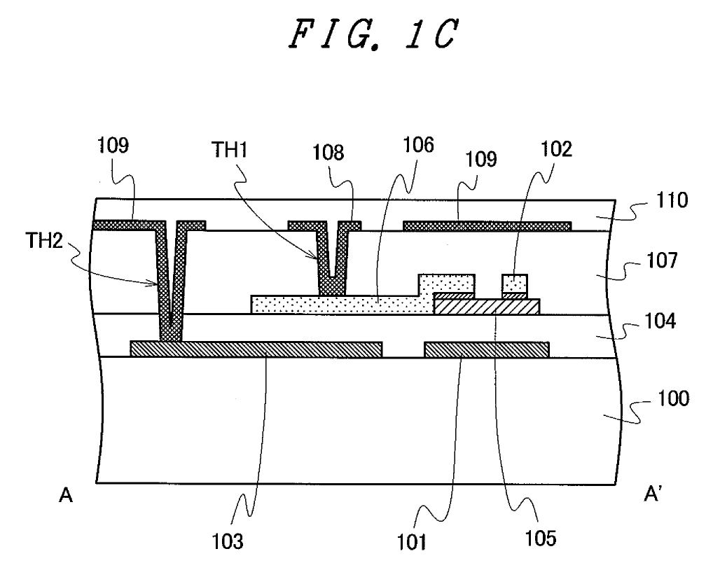

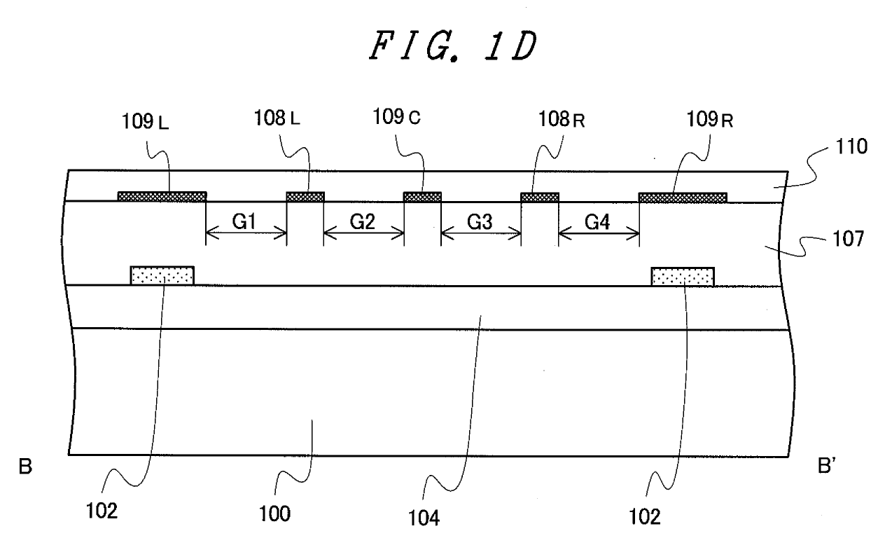

FIG. 1A to FIG. 1D are schematic views for explaining one example of the schematic constitution of a liquid crystal display panel according to the present invention.

FIG. 1A is a schematic plan view showing one example of the schematic constitution of a liquid crystal display panel according to the present invention. FIG. 1B is a schematic plan view showing one example of the schematic constitution of one pixel of a TFT substrate of the liquid crystal display panel shown in FIG. 1A. FIG. 1C is a schematic cross-sectional view showing one example of the cross-sectional constitution taken along a line A-A′ in FIG. 1B. FIG. 1D is a schematic cross-sectional view showing one example of the cross-sectional constitution taken along a line B-B′ in FIG. 1B.

The present invention is applied to a liquid crystal display panel which is used in an active-matrix-type liquid crystal display device such as a liquid crystal display for a liquid crystal television receiver set or a personal computer, for example. Here, the liquid crystal display panel includes, as shown in FIG. 1A, for example, a TFT substrate 1 and a counter substrate 2, and a liquid crystal material (not shown in the drawing) is interposed between the TFT substrate 1 and the counter substrate 2. Further, the TFT substrate 1 and the counter substrate 2 are adhered to each other by an annular sealing material (not shown in the drawing) which surrounds a display region DA, and the liquid crystal material is hermetically filled in a space surrounded by the TFT substrate 1, the counter substrate 2 and the sealing material.

The TFT substrate 1 includes a plurality of scanning signal lines 101 and a plurality of video signal lines 102. Although a portion of the scanning signal lines 101 is omitted in FIG. 1A, the plurality of scanning signal lines 101 are arranged over the whole display region DA at equal intervals, for example. In the same manner, although a portion of the video signal lines is omitted in FIG. 1A, the plurality of video signal lines are arranged over the whole display region DA at equal intervals, for example.

Further, the display region DA of the liquid crystal display panel is a region in which a plurality of pixels are arranged in a matrix array, and a region which one pixel occupies corresponds to a region surrounded by two neighboring scanning signal lines 101 and two neighboring video signal lines 102, for example. Further, each pixel includes, for example, a TFT element which functions as a switching element, a pixel electrode which is connected to a drain electrode or a source electrode of the TFT element, and a counter electrode which makes a pair with the pixel electrode. Here, the gate electrode of the TFT element of each pixel is connected to one of two neighboring scanning signal lines 101. Out of the drain electrode and the source electrode, the electrode which is not connected to the pixel electrode is connected to one of two neighboring video signal lines 102.

Further, the TFT substrate 1 is, for example, a printed circuit board in which the scanning signal lines 101, the video signal lines 102, the TFT elements, the pixel electrodes and the like are formed on a surface of an insulation substrate by stacking a plurality of conductor patterns, a plurality of semiconductor patterns, and a plurality of insulation films on a surface of the insulation substrate formed of a glass substrate or the like. Here, one pixel in the TFT substrate 1 has the constitution shown in FIG. 1B to FIG. 1D, for example.

The constitution shown in FIG. 1B to FIG. 1D is the constitution of one example of the TFT substrate 1 of a liquid crystal display panel of a lateral electric field drive type such as an IPS type. The scanning signal lines 101 and hold capacitance lines 103 are formed on the surface of the insulation substrate 100 formed of the glass substrate or the like.

Further, a first insulation layer 104 which covers the scanning signal lines 101 and the hold capacitance lines 103 is formed on the surface of the insulation substrate 100. Semiconductor layers 105 of the TFT element, the video signal lines 102 and source electrodes 106 of the TFT elements are formed on the surface of the first insulation layer 104. Here, the drain electrodes of the TFT elements are integrally formed with the video signal lines 102. Further, the semiconductor layers of the TFT elements are stacked over the scanning signal lines 101 via the first insulation layer 104. The scanning signal lines 101 function as gate electrodes of the TFT elements, and the first insulation layer 104 functions as a gate insulation film.

Further, a second insulation layer 107 which covers the video signal lines 102 and the like is formed on a surface of the first insulation layer 104, and the pixel electrodes 108 and the counter electrodes 109 are formed on the surface of the second insulation layer 107. Here, the pixel electrode 108 is connected with the source electrode 106 via a through hole TH1, and the counter electrode 109 is connected with the hold capacitance line 103 via a through hole TH2.

Further, an alignment film 110 which covers the pixel electrodes 108 and the counter electrodes 109 is formed over the surface of the second insulation layer 107.

With respect to the pixel electrode 108 and the counter electrode 109 of the pixel having the above-mentioned constitution, a portion which largely contributes to an electric field which controls the alignment of liquid crystal molecules in a liquid crystal material is a portion which extends in the extending direction (y direction) of the video signal line 102. Accordingly, the counter electrode 109 may be considered to be formed of three divided portions which respectively extend in the extending direction of the video signal line 102, that is, for example, as shown in FIG. 1D, a first counter electrode 109_{L} which is positioned above the video signal line 102 on a left edge of the pixel, a second counter electrode 109_{C} which is positioned at the center of the pixel, and a third counter electrode 109_{R} which is positioned above the video signal line on a right edge of the pixel. In the same manner, the pixel electrode 108 may be considered to be formed of two divided portions which respectively extend in the extending direction of the video signal line 102, that is, a first pixel electrode 108_{L} which passes between the first counter electrode 109_{L} and the second counter electrode 109_{C} and a second pixel electrode 108_{R} which passes between the second counter electrode 109_{C} and the third counter electrode 109_{R}.

Here, a gap G1 between the first counter electrode 109_{L} and the first pixel electrode 108_{L}, a gap G2 between the second counter electrode 109_{C} and the first pixel electrode 108_{L}, a gap G3 between the second counter electrode 109_{C} and the second pixel electrode 108_{R}, and a gap G4 between the third counter electrode 109_{R} and the second pixel electrode 108_{R} are designed to have the same value.

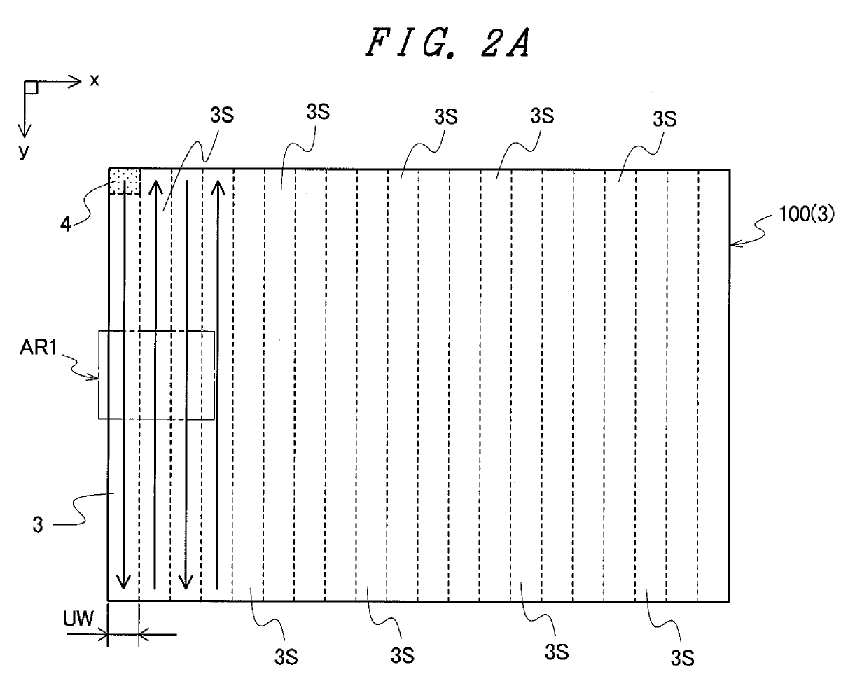

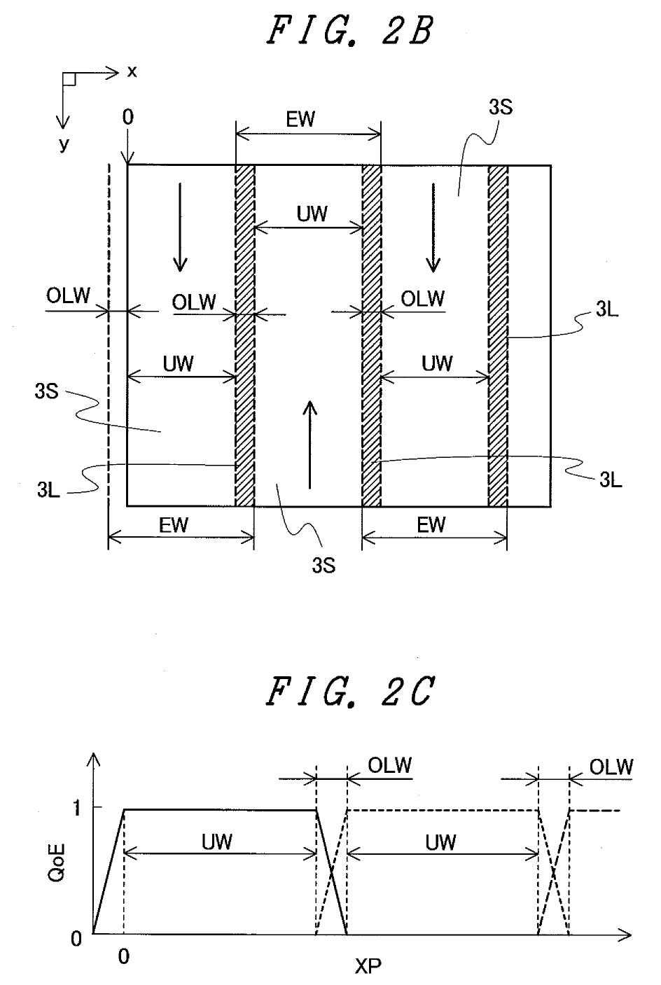

FIG. 2A to FIG. 2C are schematic views for explaining a principle of an exposure method of a photosensitive material film using a direct drawing exposure method.

FIG. 2A is a schematic plan view showing exposure steps in exposing a photosensitive material film by a direct drawing exposure method in a manufacturing step of a TFT substrate, FIG. 2B is a schematic plan view showing an area AR1 in FIG. 2A in an enlarged manner, and FIG. 2C is a schematic graph showing one example of the distribution of light quantity of exposure beams.

A manufacturing method of the TFT substrate 1 of the liquid crystal display panel includes a step of etching a conductive film, a step of etching a semiconductor film, and a step of etching an insulation film. Accordingly, in manufacturing the TFT substrate 1, an exposure/development step which exposes and develops a photosensitive material film is performed plural times.

In the manufacturing method of the TFT substrate 1, conventionally, an exposure method which uses a photo mask has been often used for exposing the photosensitive material film. However, in the manufacturing method of the liquid crystal display device (TFT substrate 1) of the present invention, an exposure method which is referred to as a direct drawing exposure method or a direct exposure method is used for exposing the photosensitive material film.

The direct drawing exposure method is an exposure method in which, for example, a photosensitive material film is divided into numerous minute regions, the respective minute regions are sorted to minute regions to be exposed and minute regions not to be exposed based on preliminarily prepared layout data (numerical value data), and the exposure is made by radiating light only to the photosensitive material film in the minute regions to be exposed thus directly drawing a latent image.

In the manufacturing method of the TFT substrate 1, in exposing the photosensitive material by the direct drawing exposure method, for example, as shown in FIG. 2A, the whole photosensitive material film 3 (exposure subject region) which is formed on a surface of the insulation substrate 100 is divided into a plurality of strip-shaped regions 3S, and the exposure of the photosensitive material is sequentially performed for every photosensitive material film 3 in the strip-shaped region 3S. Here, the photosensitive material film 3 in one strip-shaped region 3S is divided into a plurality of blocks, and the exposure of the photosensitive material film 3 is performed for every block sequentially. That is, in exposing the photosensitive material film 3 in one strip-shaped region 3S, the exposure is performed by moving (scanning) a region 4 which can be exposed by an exposure device at one time in the long-side direction (y direction) of the strip-shaped region 3S. Then, upon completion of the exposure of the photosensitive material film 3 in one strip-shaped region 3S, the region 4 which can be exposed by an exposure device at one time is moved to the next strip-shaped region 3S so as to enable the exposure of the photosensitive material film 3 in a next strip-shaped region 3S.

Here, the movement of the region 4 which can be exposed by an exposure device at one time in the y direction and in the x direction is performed such that, for example, the position of the region 4 which can be exposed by an exposure device at one time in the inside of the exposure device is fixed, and a stage (not shown in the drawing) on which the insulation substrate is mounted is moved in the y direction and in the x direction.

Further, when the exposure is performed sequentially for every photosensitive material film 3 in the strip-shaped region 3S in performing the exposure of one photosensitive material film 3, to prevent the generation of an unexposed region in a boundary portion between two neighboring strip-shaped regions 3S, for example, as shown in FIG. 2B, an overlapping region 3L having a width OLW (a size in the short-side direction) is formed on the boundary portion between two neighboring strip-shaped regions 3S.

Here, in a step of exposing the photosensitive material film 3 in one strip-shaped region 3S, the exposure is performed with respect to the photosensitive material in the strip-shaped region 3S and the photosensitive material film 3 in the neighboring overlapping regions 3L. That is, in exposing each strip-shaped region 3S shown in FIG. 2B, a region having a width EW which includes the strip-shaped region 3S and the neighboring overlapping regions 3L is exposed. Accordingly, assuming a width (a size in the short-side direction) of one strip-shaped region 3S as UW, a width (a size in the x direction) EW of light which is radiated at the time of exposing one strip-shaped region 3S is set to (UW+2×OLW) m. Here, the width UW of one strip-shaped region 3S in a conventional manufacturing method of the TFT substrate 1 is, for example, approximately 1 mm to 10 mm (for example, 4 mm), and the width OLW of one overlapping region 3L is, for example, approximately 100 μm.

In such an exposure method, one overlapping region 3L is exposed twice. Accordingly, when one strip-shaped region 3S is exposed using light having the width EW, for example, as shown in FIG. 2C, with respect to a light quantity QoE of light radiated to the overlapping region 3L, a total quantity of the light quantity at the time of first exposure and the light quantity at the time of second exposure is set equal to or more than a light quantity (exposure quantity) QoE of light having the width UW radiated to the photosensitive material film 3 in each strip-shaped region 3S.

Here, a distance (unit: arbitrary) from a left end of an exposure object position of the photosensitive material film is taken on an axis of abscissas of the graph shown in FIG. 2C. Further, a relative value of the light quantity QoE of light radiated to the photosensitive material film is taken on an axis of ordinates of the graph shown in FIG. 2C. The light quantity QoE in the strip-shaped region at one time is set to 1. Further, in the graph shown in FIG. 2C, the trapezoidal distribution indicated by a solid line is the distribution of light quantity at the time of exposing one strip-shaped region 3S, and the trapezoidal distribution indicated by a dotted line is the distribution of light quantity at the time of exposing the strip-shaped region 3S adjacent to one strip-shaped region 3S.

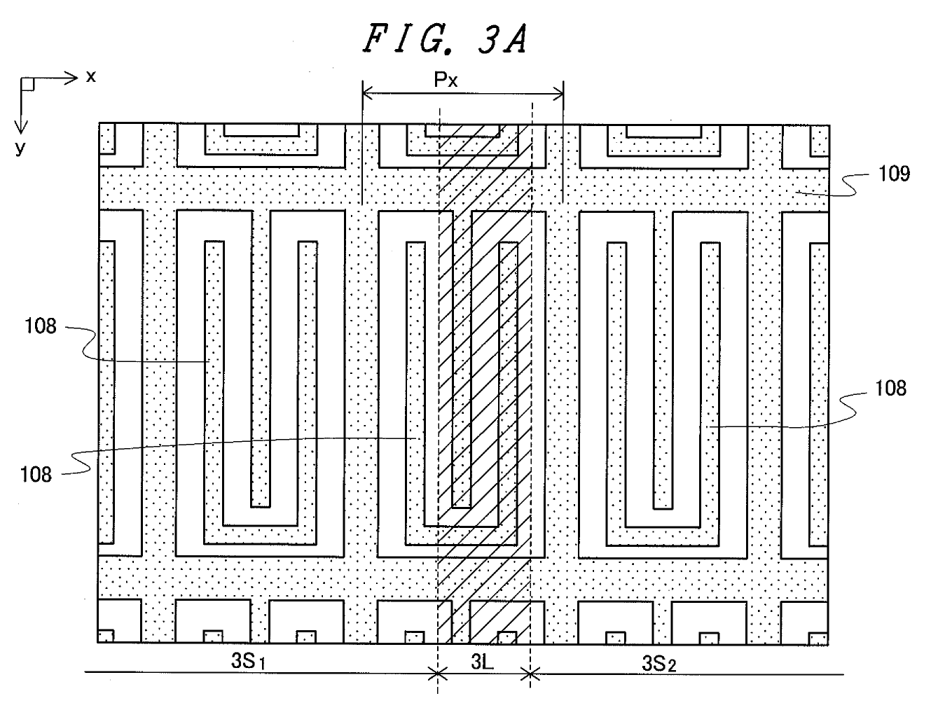

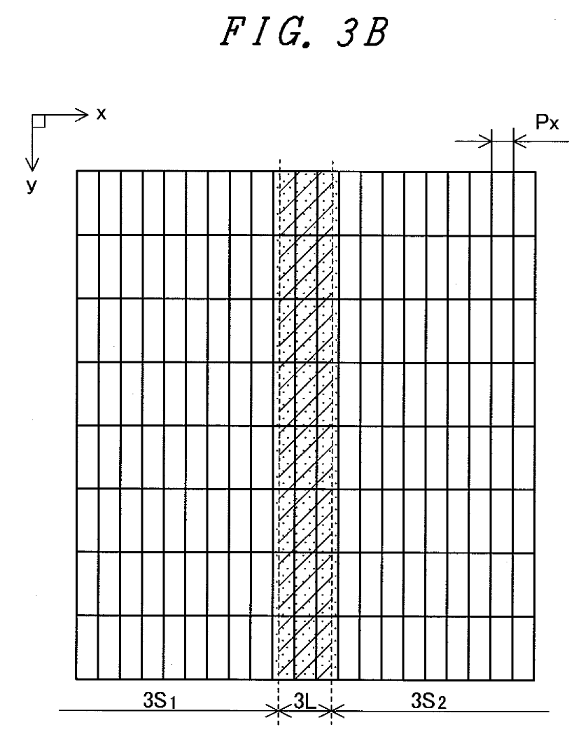

FIG. 3A is a schematic plan view showing an ideal planar layout of pixel electrodes and counter electrodes, and FIG. 3B is a schematic plan view showing one example of a size of an overlapping region in a conventional liquid crystal display device.

In the active-matrix-type liquid crystal display device of a lateral electric field drive type, in forming the pixel electrodes 108 and the counter electrodes 109, for example, as mentioned previously, the comb-teeth-shaped pixel electrode 108 which extends in the extending direction of the video signal line 102 and the comb-teeth-shaped counter electrode 109 which extends in the extending direction of the video signal line 102 are arranged alternately such that these electrodes 108, 109 mesh with each other. Such structure is formed by a direct drawing exposure method. When the exposure of a positive photo resist (photosensitive material film) at the time of forming a pattern of the pixel electrodes 108 and a pattern of the counter electrodes 109 is excessive or insufficient, that is, when the deviation of the exposure in the x direction which makes the width of the overlapping region 3L larger than a desired width occurs, a line width of the video signal line 102, a line width of the pixel electrode 108 and a line width of the counter electrode 109 in the overlapping region 3L are changed in an increasing manner or in a decreasing manner. Accordingly, in the pixel formed in the overlapping region 3L, gaps G1, G2, G3, G4 defined between the counter electrode 109 and the pixel electrode 108 assume values different from (larger than or smaller than) the gaps G1, G2, G3, G4 defined between the counter electrode 109 and the pixel electrode 108 in the pixel formed in other strip-shaped region 3S and hence, a magnitude of an electric field applied to the liquid crystal material is locally changed (weakened or strengthened).

Here, the overlapping region in the conventional liquid crystal display device is, for example, as shown in FIG. 3A, a region which extends in the x direction and has a width corresponding to several pixels arranged in the y direction. In the example shown in FIG. 3A, one cell corresponds to one pixel. Further, one pixel has the constitution shown in FIG. 1B to FIG. 1D. For example, in case of an RGB-type color display, such one pixel is referred to as a sub pixel which is a pixel which is in charge of the grayscale display of one color selected from three colors consisting of R (red), G (green) and B (blue). Here, in the x direction of the display region, the sub pixel which is in charge of the grayscale display of R, the sub pixel which is in charge of the grayscale display of G, and the sub pixel which is in charge of the grayscale display of B are repeatedly arranged in this order. Here, three sub pixels consisting of the sub pixel in charge of the grayscale display of R, the sub pixel in charge of the grayscale display of G, and the sub pixel in charge of the grayscale display of B express color of 1 dot of a video or an image. In this manner, in the conventional liquid crystal display device, the width OLW of the overlapping region 3L is the width corresponding to several pixels arranged in the y direction and hence, when a gap between the pixel electrode 108 and the counter electrode 109 in the overlapping region 3L is changed, such a change is recognized as stripe-shaped irregularities.

Further, the overlapping regions 3L are periodically present at fixed intervals in the x direction. Accordingly, when the gap between the pixel electrode 108 and the counter electrode 109 is changed in the respective overlapping regions, such a change is recognized as periodical stripe-shaped irregularities.

Inventors of the present invention have made the following finding in the course of studying a method which reduces periodical stripe-shaped irregularities in a liquid crystal display device having a TFT substrate 1 manufactured by a manufacturing method which exposes a photosensitive material film by a direct drawing exposure method. That is, the inventors of the present invention have found that the relationship expressed by the following Table 1 exists between a size of the width OLW of one overlapping region 3L and a visual acuity S_{dis} which allows a viewer to recognize the periodical stripe-shaped irregularities with his/her naked eyes, for example.

TABLE 1

OLW (μm)

| | 100 | 80 | 60 | 50 | 40 | 30 | 20 | 10 |
|---|---|---|---|---|---|---|---|---|
| S_{dis} | 0.9 | 1.1 | 1.5 | 1.7 | 2.2 | 2.9 | 4.4 | 8.7 |

Here, the above Table 1 shows a result acquired in the following manner, for example. There is prepared a liquid crystal display device having the TFT substrate 1 which is manufactured such that, in exposing the photosensitive material film 3 by a direct drawing exposure method, the width UW of one strip-shaped region 3S is set to 4 mm, and the exposure is performed by changing setting of the width OLW of one overlapping region 3L. Then, the whole surface of the display region DA of the liquid crystal display device is displayed in white or black, and a minimum value of visual acuity which allows a viewer to recognize periodical stripe-shaped irregularities with his/her naked eyes as viewed from a position 30 cm away from a display surface (liquid crystal display panel) is estimated by simulation.

In the relationship shown in the above Table 1, for example, when the width OLW of one overlapping region 3L is set to 80 μm, a viewer having a visual acuity of 1.1 or more can recognize the periodical stripe-shaped irregularities. Further, when the width OLW of one overlapping region 3L is set to 50 μm, a viewer having a visual acuity of 1.7 or more can recognize the periodical stripe-shaped irregularities. In the same manner, when the width OLW of one overlapping region 3L is set to 40 μm, a viewer having a visual acuity of 2.2 or more can recognize the periodical stripe-shaped irregularities.

That is, according to the relationship shown in the above Table 1, by setting the width OLW of one overlapping region 3L to 50 μm or less, even when the planar shape of the conductor pattern (for example, the pixel electrode 108 and the counter electrode 109) in the overlapping region 3L becomes a shape different from the planar shape in layout data or the planar shape of the conductor pattern formed in the strip-shaped region 3S so that the characteristic of the pixel is changed, it is considered difficult for a viewer to recognize the periodical stripe-shaped irregularities. Particularly, when the width OLW of one overlapping region 3L is set to 20 μm or less, only a viewer having a visual acuity of 4.4 or more can recognize the periodical stripe-shaped irregularities and hence, it is safe to say that nobody can practically recognize the periodical stripe-shaped irregularities. Accordingly, by setting the width OLW of one overlapping region 3L to 50 μm or less, and more preferably 20 μm or less, image quality can be enhanced.

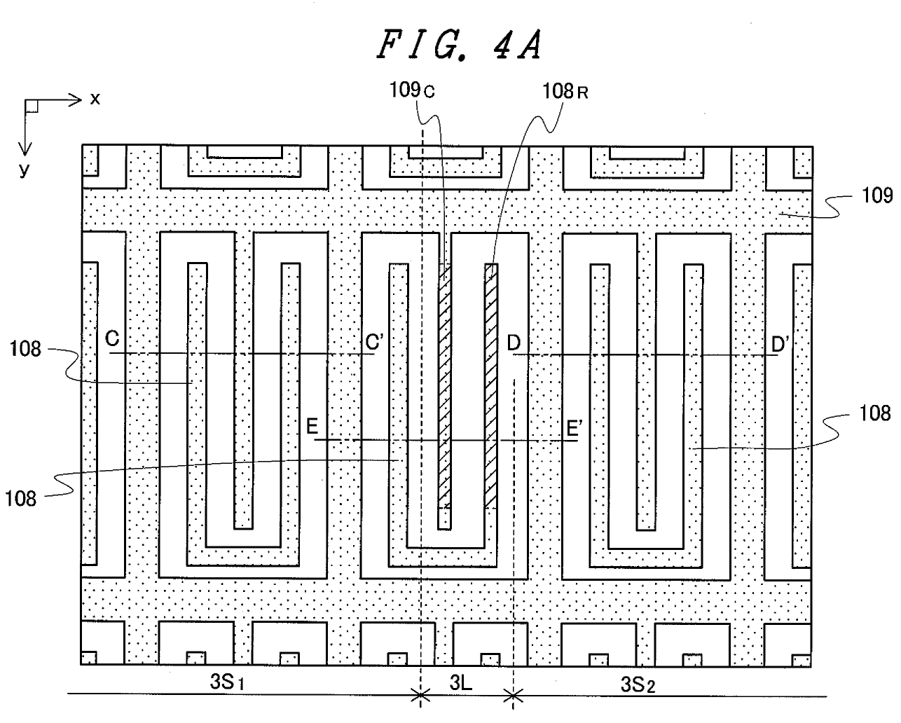

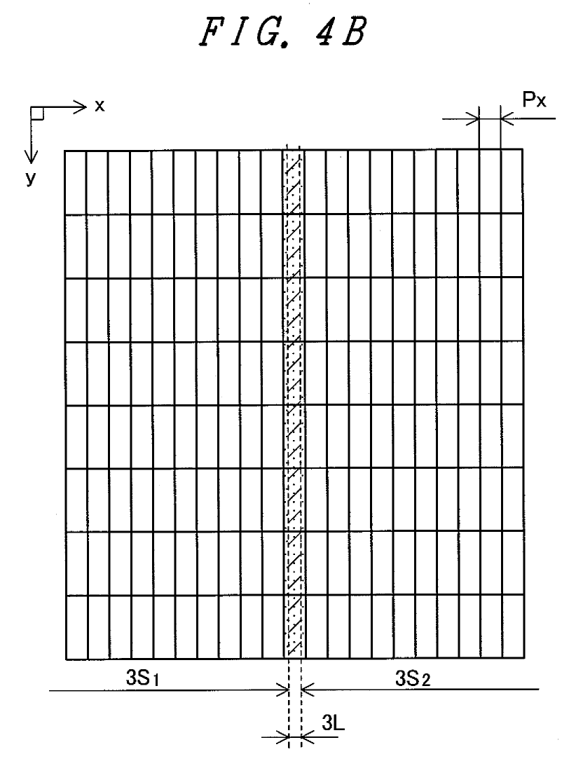

FIG. 4A is a schematic plan view showing one example of a change of planar shapes of the pixel electrodes and counter electrodes which occurs in an overlapping region. FIG. 4B is a schematic plan view showing one example of a size of an overlapping region in a liquid crystal display device to which the present invention is applied.

In an active-matrix-type liquid crystal display device to which the present invention is applied, in performing the exposure of a photosensitive material film 3 in a first strip-shaped region 3S₁ and a photosensitive material film 3 in an overlapping region 3L using a direct drawing exposure method and, thereafter, in performing the exposure of the photosensitive material film 3 in a second strip-shaped region 3S₂ and the photosensitive material film 3 in the overlapping region 3L using a direct drawing exposure method, a width OLW of one overlapping region 3L is set to 50 μm or less, for example. Here, when the positional deviation in the x direction attributed to positional accuracy of a stage on which an insulation substrate 100 is mounted occurs in the region to be exposed, the pixel electrode 108 and the counter electrode 109 on the periphery of the overlapping region 3L have the planar shape shown in FIG. 4B, for example.

A size Px of one pixel (sub pixel) in the x direction on a TFT substrate 1 of a liquid crystal display panel used in a liquid crystal television receiver set or the like is 50 μm or more in general. Accordingly, when the width of one overlapping region 3L is 50 μm or less, for example, as shown in FIG. 4B, the overlapping region 3L is present only on one column of pixels arranged in the y direction.

Here, the planar shape of the pixel electrode 108 and the counter electrode 109 of the pixel which is entirely present in the first strip-shaped region 3S₁ and the pixel which is entirely present in the second strip-shaped region 3S₂ is congruent with or similar to the planar shape in layout data. Accordingly, values of gaps G1, G2, G3, G4 between the pixel electrode 108 and the counter electrode 109 of the pixel which is entirely present in the first strip-shaped region 3S₁ and the pixel which is entirely present in the second strip-shaped region 3S₂ are substantially equal to the corresponding values in the layout data. That is, the cross-sectional constitution taken along a line C-C′ in FIG. 4B and the cross-sectional constitution taken along a line D-D′ in FIG. 4B are respectively equal to the corresponding cross-sectional constitutions shown in FIG. 1D.

To the contrary, in the pixel which passes the overlapping region 3L, with respect to the planar shape of the pixel electrode 108 and the counter electrode 109, a portion of the planar shape which overlaps with the overlapping region 3L is influenced by the positional deviation at the time of exposure and hence, the planar shape becomes a shape different from the planar shape in the layout data or the planar shape of the pixel in the strip-shaped regions 3S₁, 3S₂. Here, to observe the cross-sectional constitution taken along a line E-E′ in FIG. 4B, although such cross-sectional constitution is similar to the cross-sectional constitution shown in FIG. 1D, electrode widths of portions which extend to and partially cover the overlapping region 3L, that is, an electrode width (a size in the x direction) of a portion of the pixel electrode 108 which extends in the extending direction of the video signal line (second pixel electrode 108_{R}), and an electrode width (a size in the x direction) of a portion of the counter electrode 109 which extends in the extending direction of the video signal line (second counter electrode 109_{C}) become smaller than electrode widths of other portions. Accordingly, a value of the gap G3 out of the gaps G1, G2, G3, G4 in the pixel becomes larger than values of other gaps G1, G2, G4 and values of the gaps G1, G2, G3, G4 in the pixel in the strip-shaped region 3S (other than the overlapping region 3L). Accordingly, for example, when all pixels are displayed with same brightness (grayscale), the brightness of the pixel which passes the overlapping region 3L differs from the brightness of the pixel which is entirely present in the strip-shaped region 3S.

However, when the width OLW of the overlapping region 3L is set to 50 μm or less as shown in the above Table 1, only a viewer having visual acuity of 1.7 or more can, in principle, recognize periodical stripe-shaped irregularities. Further, in the liquid crystal display panel having the TFT substrate 1 which is manufactured by the manufacturing method of the embodiment 1, for example, the overlapping region 3L is present only on one column of pixels arranged in the y direction. A change of characteristic of the pixel (sub pixel) attributed to a change of the planar shape in the overlapping region 3L occurs only with respect to pixels corresponding to one color out of one dot of a video or an image, for example. Accordingly, when the width OLW of the overlapping region 3L is set to 50 μm or less, only a viewer having visual acuity of 2.0 or more can practically recognize the periodical stripe-shaped irregularities.

In the exposure method of the embodiment 1, depending on the manner of setting of the width UW of the strip-shaped region 3S and the width OLW of the overlapping regions 3L, for example, one overlapping region 3L may extend to and partially cover two pixels which are arranged adjacent to each other with one video signal line 102 sandwiched therebetween. However, even in such a case, by setting the width OLW of one overlapping region 3L to 50 μm or less, a degree of deformation of the planar shape of the pixel electrode 108 and the counter electrode 109 between two pixels is small and hence, the difference between the characteristic of these two pixels and the characteristic of pixel which is entirely present in the strip-shaped region 3S is small. Accordingly, even when one overlapping region 3L extends to and partially covers two pixels arranged adjacent to each other with one video signal line 102 sandwiched therebetween, a viewer can hardly recognize the periodical stripe-shaped irregularities.

As explained above, according to the manufacturing method of the liquid crystal display device (TFT substrate 1) of the embodiment 1, the method can easily manufacture the liquid crystal display device which makes it difficult for a viewer to recognize the periodical stripe-shaped irregularities corresponding to the overlapping regions 3L which are formed at the time of exposing the photosensitive material film 3 using a direct drawing exposure method. That is, by manufacturing the TFT substrate 1 by adopting the exposure method explained in conjunction with the embodiment 1, it is possible to decrease the periodical stripe-shaped irregularities of the liquid crystal display device.

Further, in the manufacturing method of the liquid crystal display device (TFT substrate 1) of the embodiment 1, it is sufficient to merely change the setting of the width OLW of the overlapping region 3L formed between two neighboring strip-shaped regions 3S. Accordingly, the manufacturing method of the liquid crystal display device of the embodiment 1 can ensure the productivity substantially equal to the productivity of a conventional manufacturing method of a liquid crystal display device having a step which exposes a photosensitive material film 3 by a direct drawing exposure method.

Further, the embodiment 1 exemplifies the exposure method which is performed in the step of forming the pixel electrode 108 and the counter electrode 109. However, the present invention is not limited to such an example. For example, it is needless to say that the method explained in conjunction with the embodiment 1 is applicable to the exposure which is performed in a step of forming the video signal line 102 (including the drain electrode of the TFT element) and the source electrode 106 or the like.

Further, the embodiment 1 exemplifies the manufacturing method of the pixel electrode 108 and the counter electrode 109 on the TFT substrate 1 having the pixels of the constitution shown in FIG. 1B to FIG. 1D. However, it is needless to say that the present invention is not limited to such an example. That is, the method explained in conjunction with the embodiment 1 is also applicable to the manufacture of the TFT substrate 1 having pixels of the constitution which differs from the constitution shown in FIG. 1B to FIG. 1D.

Further, inventors of the present invention actually manufactured the liquid crystal display panel of the present invention on a trial basis or as a prototype. As a result, stripe-shaped irregularities which were observed in the conventional liquid crystal display panel were not observed. Then, whether or not the brightness irregularities are eliminated was measured using a two-dimensional brightness meter (equivalent to CA-2000 manufactured by Konica Minolta Holdings, Inc.). As a result of the measurement, the brightness change was detected at fixed pitches. The brightness change portion was analyzed and investigated, line widths were measured using an SEM, and a width of a line-width changed region was measured. The width of the line-width changed region was 20 μm. As can be understood from the result of the experiment, by setting the width of the region where the width of the pixel electrode 108 and the width of the counter electrode 109 differ from other region to 50 μm, more preferably 20 μm, it was confirmed that although the brightness change exists, such a brightness change is not recognized as stripe-shaped irregularities.

### Embodiment 2

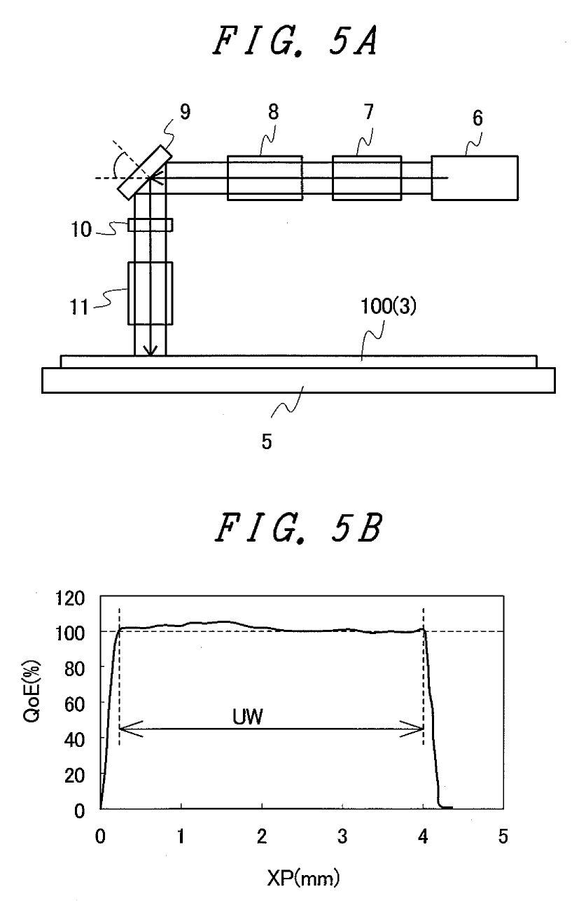

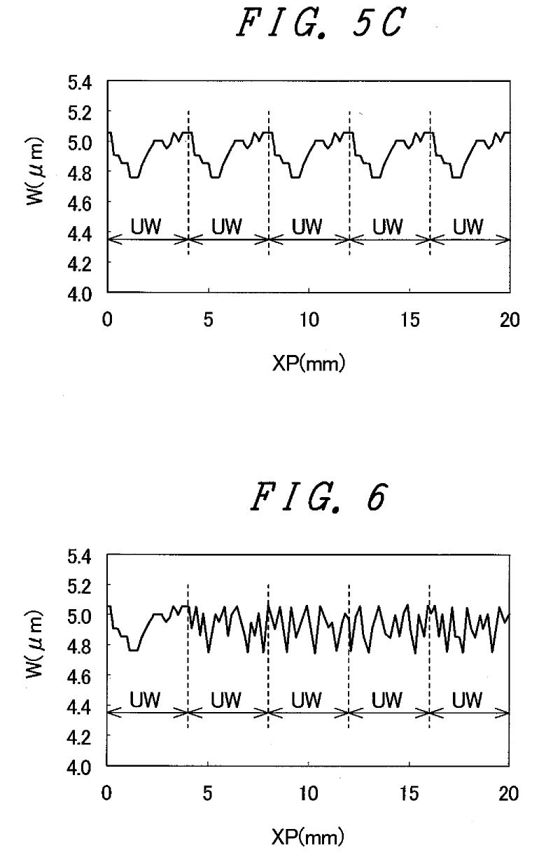

FIG. 5A to FIG. 5C are schematic views for explaining one example of the schematic constitution of a conventional exposure device adopting a direct drawing exposure method and one example of drawback which occurs when a photosensitive material film is exposed using the exposure device.

FIG. 5A is a schematic view showing one example of the schematic constitution of the exposure device adopting a direct drawing exposure method. FIG. 5B is a schematic graph showing one example of the distribution of light quantity of light radiated when one strip-shaped region is exposed. FIG. 5C is a schematic graph showing one example of the distribution of a line width in a conventional exposure method.

The exposure device adopting a direct drawing exposure method includes, for example, as shown in FIG. 5A, a stage 5 on which an insulation substrate 100 which forms a photosensitive material film 3 on a surface thereof is mounted, a laser beam source 6, an optical fiber 7, an illumination optical system 8, a spatial light modulator 9, a diffraction light filter 10, and a projection optical system 11.

In using the exposure device having such constitution, first of all, laser beams radiated from the laser beam source 6 are radiated to the spatial light modulator 9 via the optical fiber 7 and the illumination optical system 8. The spatial light modulator 9 is, for example, an MEMS (Micro Electro Mechanical System) which makes use of optical diffraction referred to as a GLV (Grating Light Valve). The spatial light modulator 9 forms a one-dimensional pattern which conforms to layout data such as CAD data using a reflective diffraction light. The reflective diffraction light passes through the diffraction light filter 10 and the projection optical system 11, and is projected on the photosensitive material film 3 formed on the surface of the insulation substrate 100 at magnification of 1/10, for example.

Here, the laser beam source 6, the optical fiber 7, the illumination optical system 8, the spatial light modulator 9, the diffraction light filter 10 and the projection optical system are fixedly mounted in the inside of the exposure device, for example. By repeating the projection of the reflective diffraction light by moving the stage 5 in the y direction as well as in the x direction, the whole photosensitive material film 3 is exposed.

In FIG. 5A, only one optical unit constituted of the laser beam source 6, the optical fiber 7, the illumination optical system 8, the spatial light modulator 9, the diffraction light filter 10 and the projection optical system 11 is shown. However, an actual exposure device includes a plurality of optical units, for example, eight optical units.

Here, when the calibration is carried out using the spatial light modulator 9 (for example, GLV), the distribution of light quantity of light radiated to the photosensitive material film 3 assumes the substantially trapezoidal distribution as shown in FIG. 5B, for example. A distance XP (mm) from a left end of an exposure subject region of the photosensitive material film 3 is taken on an axis of abscissas of the graph shown in FIG. 5B. Further, a relative value (%) of the light quantity QoE is taken on an axis of ordinates of the graph shown in FIG. 5B. Here, the minimum light quantity necessary for completely exposing the photosensitive material film 3 is set to 100%.

In this manner, in the actual exposure device, there arises irregularities of approximately ±5% locally in the distribution of light quantity QoE in a zone UW where one strip-shaped region 3S is exposed in the distribution of light quantity of light radiated to the photosensitive material film 3. Then, for example, the pixel electrode 108 and the counter electrode 109 are formed by using an etching resist obtained by performing the exposure with light having such a distribution state of light quantity QoE and, thereafter, by performing development as a mask. The distribution of the line width W of the pixel electrode 108 is periodically changed as shown in FIG. 5C, for example. Here, the distance XP (mm) from a left end of the exposure subject region of the photosensitive material film 3 is taken on the axis of abscissas of the graph shown in FIG. 5C. Further, the line width W (μm) of the pixel electrode 108 is taken on an axis of ordinates of the graph shown in FIG. 5C. That is, the graph shown in FIG. 5C shows a change of the line width W of the pixel electrode 108 in a plurality of pixels arranged in the x direction.

Here, the line width W of the pixel electrode 108 in the plurality of pixels arranged in the x direction exhibits the distribution which has a cycle of the same width as the width UW of light radiated to one strip-shaped region 3S (for example, a cycle of 4 mm).

Accordingly, the manufacturing method of the TFT substrate which exposes the photosensitive material film using the conventional exposure device adopting a direct drawing exposure method has a drawback that periodical irregularities are liable to be easily generated attributed to a periodical change of a size of a pattern in the pixel present in the strip-shaped region 3S separately from the periodical stripe-shaped irregularities attributed to the deformation of the planar shape of the pattern in the overlapping region 3L.

FIG. 6 is a schematic graph showing one example of the manner of operation and advantageous effects of a manufacturing method of a TFT substrate of the embodiment 2 according to the present invention.

In the manufacturing method of a TFT substrate 1 of the embodiment 2, to decrease the periodical irregularities attributed to the periodical change of the size of the pattern in the pixel present in the stripe-shaped region 3S, in performing the exposure of the photosensitive material film, for example, a calibration correction value of the spatial light modulator 9 (GLV) is added for every strip-shaped region 3S, and random processing is added to such a correction value in exposure. In this manner, when the photosensitive material film is exposed while performing the random processing for every strip-shaped region 3S, the distribution of the line width W of the pixel electrode 108 in the plurality of pixels arranged in the x direction exhibits a change shown in FIG. 6, for example. Here, a distance XP (mm) from a left end of an exposure subject region of a photosensitive material film 3 is taken on an axis of abscissas of the graph shown in FIG. 6. Further, a line width W (μm) of the pixel electrode 108 is taken on an axis of ordinates of the graph shown in FIG. 6.

Here, the line width of W of the pixel electrode 108 in the pixel present in the strip-shaped region 3S to be exposed firstly exhibits the substantially equal change as the distribution shown in FIG. 5C. However, with respect to the line width W of the pixel electrode 108 in the pixel present in the strip-shaped region 3S to be exposed secondly and thereafter, no periodicity is found by adding random processing to the calibration correction value. Accordingly, by manufacturing the TFT substrate 1 by applying the exposure method explained in conjunction with the embodiment 2, the periodical irregularities attributed to the periodical change of the size of the pattern in the pixel present in the strip-shaped region 3S in the liquid crystal display device can be decreased to a level which makes it difficult for a viewer to recognize the periodical irregularities.

In the embodiment 2, the GLV is exemplified as one example of the spatial light modulator 9. However, it is needless to say that the spatial light modulator 9 is not limited to the GLV. That is, a DMD (Digital Micromirror Device) may be used as the spatial light modulator 9, for example.

Further, in the embodiment 2, the example in which the width UW of one strip-shaped region 3S is 4 mm is exemplified. However, the width UW of the strip-shaped region 3S is not limited to such a value. For example, the width UW of the strip-shaped region 3S may be suitably changed within a range from 1 mm or more to 10 mm or less.

Although the present invention has been specifically explained in conjunction with embodiments, it is needless to say that the present invention is not limited to such embodiments, and various modifications can be made without departing from the gist of the present invention.

For example, in the embodiment 1 and the embodiment 2, the exposure method which is used in the manufacture of the TFT substrate 1 having the pixels of the constitution shown in FIG. 1B to FIG. 1D is exemplified. However, it is needless to say that the present invention is not limited to such an exposure method, and is also applicable to the exposure method which is used in the manufacture of the TFT substrate 1 having the pixels of different constitution.

Further, in the embodiment 1 and the embodiment 2, the exposure method which is used in the manufacture of the TFT substrate 1 of the relatively large-sized liquid crystal display panel used in a liquid crystal television receiver set is exemplified. However, it is needless to say that the present invention is applicable to an exposure method which is used in the manufacture of a TFT substrate 1 of a relatively miniaturized liquid crystal display panel for portable electronic equipment such as a mobile phone, for example.

Further, in the embodiment 1 and the embodiment 2, the exposure method which is used in the manufacture of the TFT substrate 1 of the liquid crystal display panel is exemplified. However, it is needless to say that the present invention is not limited to such an exposure method, and is also applicable to an exposure method which is used in the manufacture of a printed circuit board having the substantially same constitution as the TFT substrate 1, for example, a printed circuit board of a self-luminous-type display panel using organic EL or the like.

What is claimed is:

1. An active-matrix-type liquid crystal display device comprising:
video signal lines;
scanning signal lines;
TFT elements which are formed corresponding to intersecting points of the video signal lines and the scanning signal lines;
pixel electrodes which are connected to the TFT elements;
a liquid crystal layer arranged above the pixel electrodes; and
counter electrodes which are arranged to face the pixel electrodes in an opposed manner, wherein
each pixel is configured such that the pixel electrode includes a first portion which extends in the extending direction of the video signal lines, and the counter electrode includes a second portion which extends in the extending direction of the video signal lines,
a display region includes first regions which are regions extending in the extending direction of the video signal lines and are arranged at fixed intervals in the extending direction of the scanning signal lines,
line widths of the first portion, the second portion and the video signal line in the first region are respectively set different from line widths of the first portion, the second portion and the video signal line in other region, and
a width of the first region is set to 50 μm or less.

2. An active-matrix-type liquid crystal display device according to claim 1, wherein the width of the first region is set to 20 μm or less.

3. An active-matrix-type liquid crystal display device according to claim 1, wherein respective gaps between the first portion, the second portion and the video signal line in the first region are set different from respective gaps between the first portion, the second portion and the video signal line in said other region.

4. An active-matrix-type liquid crystal display device according to claim 2, wherein respective gaps between the first portion, the second portion and the video signal line in the first region are set different from respective gaps between the first portion, the second portion and the video signal line in said other region.

5. An active-matrix-type liquid crystal display device comprising:
video signal lines;
scanning signal lines;
TFT elements which are formed corresponding to intersecting points of the video signal lines and the scanning signal lines;
pixel electrodes which are connected to the TFT elements;
a liquid crystal layer arranged above the pixel electrodes; and
counter electrodes which are arranged to face the pixel electrodes in an opposed manner, wherein
each pixel is configured such that the pixel electrode includes a first portion which extends in the extending direction of the video signal lines, and the counter electrode includes a second portion which extends in the extending direction of the video signal lines,
a display region includes first regions which are regions extending in the extending direction of the video signal lines and are arranged at fixed intervals in the extending direction of the scanning signal lines,
gaps between the first portion, the second portion and the video signal line in the first region are respectively set different from gaps between the first portion, the second portion and the video signal line in other region, and
a width of the first region is set to 50 μm or less.

6. An active-matrix-type liquid crystal display device according to claim 5, wherein the width of the first region is set to 20 μm or less.

7. A manufacturing method of a display device which performs an exposure/development step for exposing and developing a photosensitive material film plural times in a process of forming a printed circuit board which forms scanning signal lines, video signal lines, TFT elements, pixel electrodes, and counter electrodes on a surface of an insulation substrate, wherein
the exposure of the photosensitive material film performed in the exposure/development step one time is performed such that an exposure subject region of the photosensitive material film is divided into a plurality of strip-shaped regions, and the exposure is sequentially performed for every photosensitive material film in the strip-shaped region using an exposure device,
the exposure is performed while forming, between a first strip-shaped region and a second strip-shaped region which is arranged adjacent to the first strip-shaped region, a strip-shaped overlapping region which is exposed in both of exposing the photosensitive material film in the first strip-shaped region and exposing the photosensitive material film in the second strip-shaped region, and
a size of the overlapping region in the short-side direction is set to 50 μm or less.

8. A manufacturing method of a display device according to claim 7, wherein a size of the overlapping region in the short-side direction is set to 20 μm or less.
